(19) United States
(12) Patent Application Publication
(10) Pub. No.: US 2026/0295493 A1
(43) Pub. Date: Oct. 1, 2026

(54) AIR FILTRATION SYSTEM WITH MAIN AND SUBSIDIARY ASSEMBLIES

(71) Applicant: Apex Brands, Inc., Apex, NC (US)

(72) Inventor: Mikael THOREN, Lidköping (SE)

(21) Appl. No.: 19/489,343

(22) PCT Filed: Apr. 30, 2024
(86) PCT No.: PCT/US2024/026971

§ 371 Date: Dec. 2, 2025

Related U.S. Application Data
(60) Provisional application No. 63/472,859, filed on Jun. 14, 2023.

(51) Int. Cl. B01D 46/46; B01D 46/00; B23K 3/02

(52) U.S. Cl. CPC B01D 46/46; B01D 46/0086; B23K 3/029

(57) ABSTRACT

An air filtration system for filtering gas or particles generated responsive to operation of a work tool may include a main assembly and a plurality of subsidiary assemblies operably coupled to the main assembly. The main assembly and the plurality of subsidiary assemblies may include an intake which may be repositionable relative to the work tool, a housing which may be operably coupled to the intake and may include a filter and a motor, and an exhaust operably coupled to the housing. Air may enter the air filtration assembly at the intake responsive to operation of the motor, before passing through the filter and exiting out the exhaust. The main assembly may further include processing circuitry which may control the operation of both the main assembly and each subsidiary assembly of the plurality of subsidiary assemblies.

### TECHNICAL FIELD

Example embodiments generally relate to air filtration systems and, in particular, relate to such systems having multiple filtration assemblies working together.

### BACKGROUND

Many tasks or processes that may commonly take place in manufacturing or lab settings may generate unwanted byproducts in various forms. For example, processes involving certain materials and chemicals may create waste that may need to be dealt with appropriately either via proper disposal or cleaning. In some cases, the byproducts may be airborne and may require the use of an air filtration system to dispose of them accordingly. One such task that may generate airborne byproducts may be soldering. Soldering tools, which are sometimes referred to as soldering irons or soldering guns, are commonly used in electronics manufacturing and repair activities along with other crafts and industries that involve metalwork. Soldering tools are typically used to join metallic items together at a joint by melting a filler metal (i.e., solder) into the joint. A tip portion of the soldering tool may, due to operation of a heater, become hot enough to melt solder that contacts the tip portion. The act of melting the solder, and thus soldering in general, may release gas into the air that may contain volatile organic compounds (VOC's) or other chemicals.

Soldering and other related tasks may often be performed at a workstation indoors. In some cases, the workstation may be located proximate to other workstations and sometimes within the same room. Thus, an air filtration system may be employed to filter the air proximate to the workstation where the task may be taking place. Common considerations to make regarding the configuration and use of the air filtration system may include ensuring it is adequately sized for the space it is occupying, ensuring it is operating effectively, and improving its overall ease of operation/user experience. Thus, it may be desirable to provide an improved air filtration system to address some of the above considerations to create an environment that may be safer for the operator and other potential surrounding workstations.

### BRIEF SUMMARY OF SOME EXAMPLES

In an example embodiment, an air filtration system for filtering gas or particles generated responsive to operation of a work tool may be provided. The air filtration system may include a main assembly and a plurality of subsidiary assemblies operably coupled to the main assembly. The main assembly and the plurality of subsidiary assemblies may include an intake which may be repositionable relative to the work tool, a housing which may be operably coupled to the intake and may include a filter and a motor, and an exhaust operably coupled to the housing. Air may enter the air filtration assembly at the intake responsive to operation of the motor, before passing through the filter and exiting out the exhaust. The main assembly may further include processing circuitry which may control the operation of both the main assembly and each subsidiary assembly of the plurality of subsidiary assemblies.

In another example embodiment, a main assembly for an air filtration system for filtering gas or particles generated responsive to operation of a work tool may be provided. The main assembly may include an intake which may be repositionable relative to the work tool, a housing which may be operably coupled to the intake and may include a filter and a motor, and an exhaust operably coupled to the housing. Air may enter the main assembly at the intake responsive to operation of the motor, before passing through the filter and exiting out the exhaust. The main assembly may further include processing circuitry configured to control the operation the main assembly and a plurality of subsidiary assemblies that lack local processing circuitry and may be operably coupled to the main assembly.

In another example embodiment, a subsidiary assembly for an air filtration system for filtering gas or particles generated responsive to operation of a work tool may be provided. The subsidiary assembly may include an intake which may be repositionable relative to the work tool, a housing which may be operably coupled to the intake and may include a filter and a motor, and an exhaust operably coupled to the housing. Air may enter the subsidiary assembly at the intake responsive to operation of the motor, before passing through the filter and exiting out the exhaust. The subsidiary assembly may be operably coupled to a main assembly that may include processing circuitry configured to control the operation the main assembly and of the subsidiary assembly, which may lack local processing circuitry.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of an air filtration system according to an example embodiment;

FIG. 2 illustrates a block diagram of a main assembly of the air filtration system of FIG. 1 according to an example embodiment;

FIG. 3 illustrates a block diagram of a subsidiary assembly of the air filtration system of FIG. 1 according to an example embodiment;

FIG. 4 illustrates a perspective view of the main assembly of the air filtration system of FIG. 1 set up at a workstation in accordance with an example embodiment;

FIG. 5 illustrates a perspective view of the air filtration system of FIG. 1 set up at respective workstations in accordance with an example embodiment; and

FIG. 6 illustrates a perspective view of the air filtration system of FIG. 1 set up in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of an air filtration system that includes a plurality of air filtration assemblies to expand and improve the air filtration system's operation. In some cases, the air filtration system may include a main assembly and a plurality of subsidiary assemblies. The main assembly may control its own operation in addition to the operation of the plurality of subsidiary units. However, other strategies and features are also contemplated as described in greater detail below.

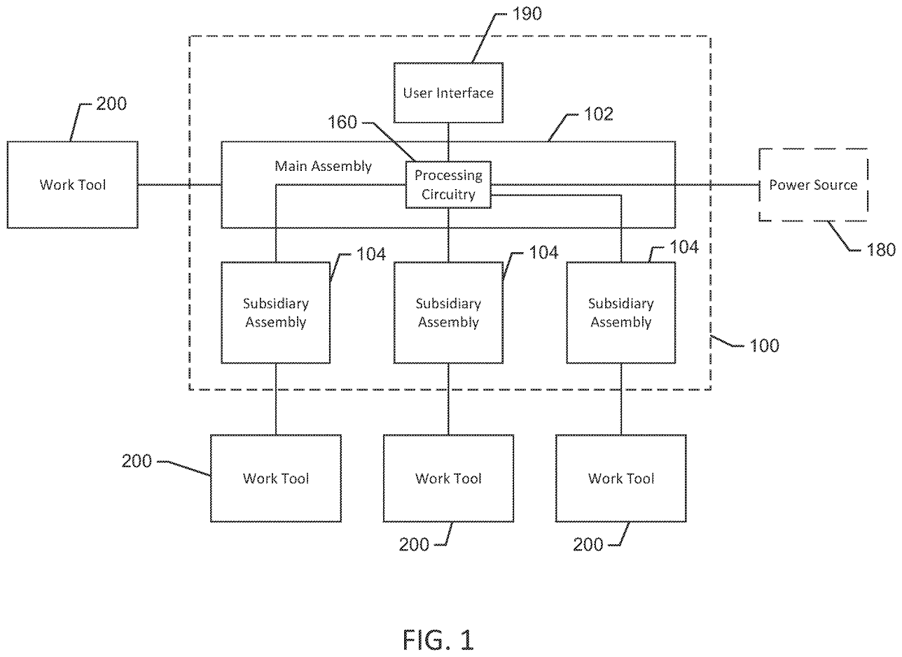

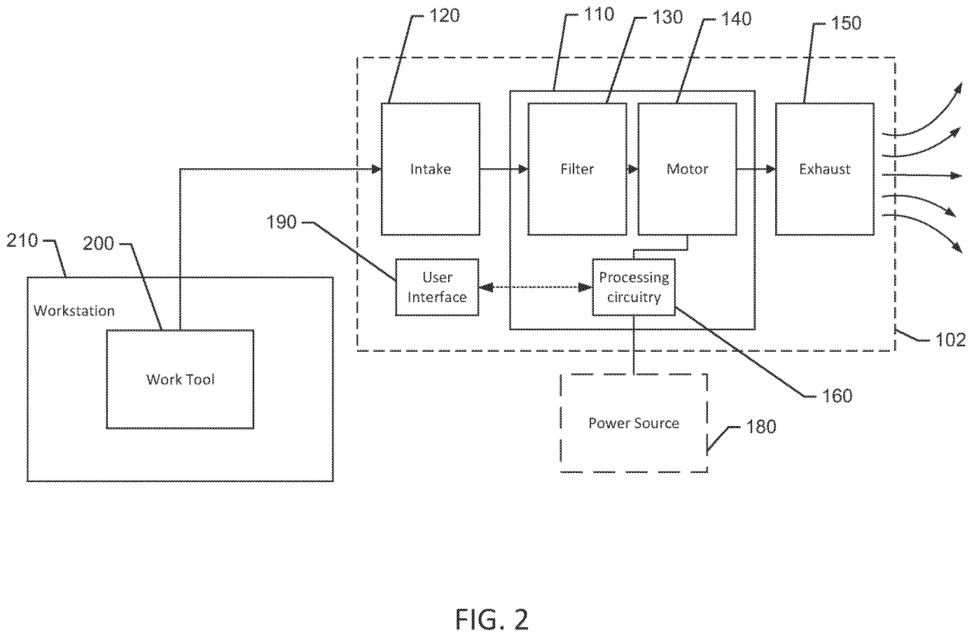

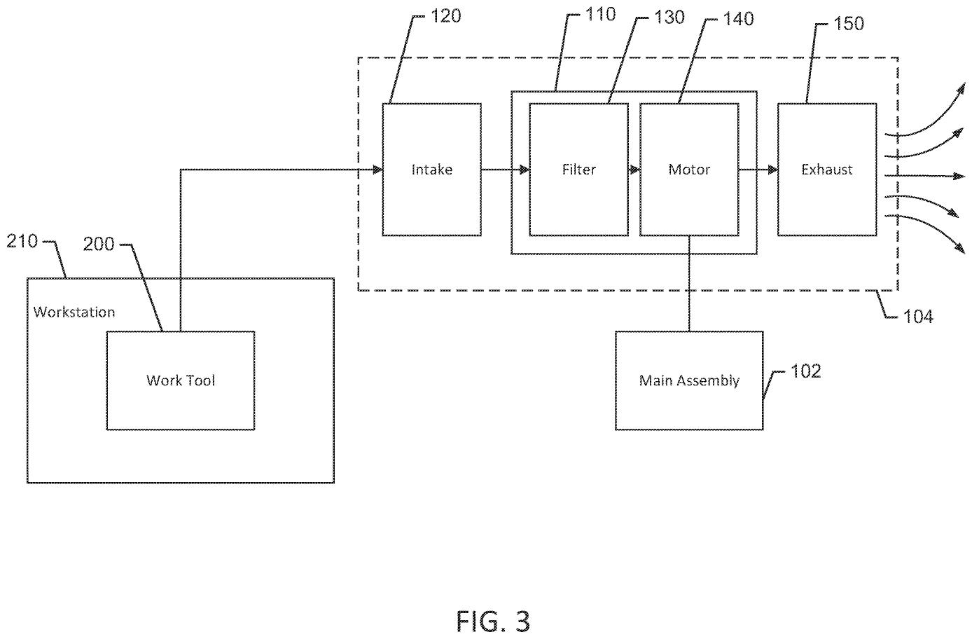

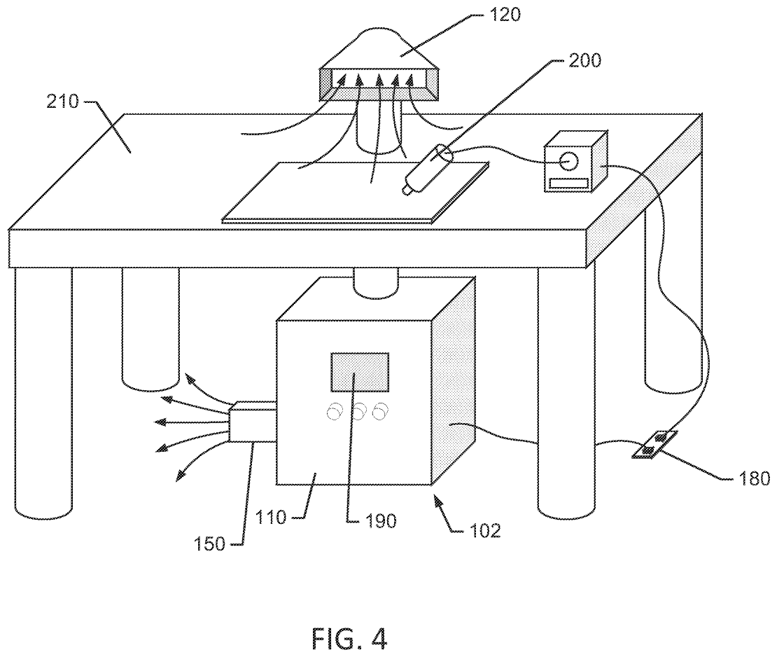

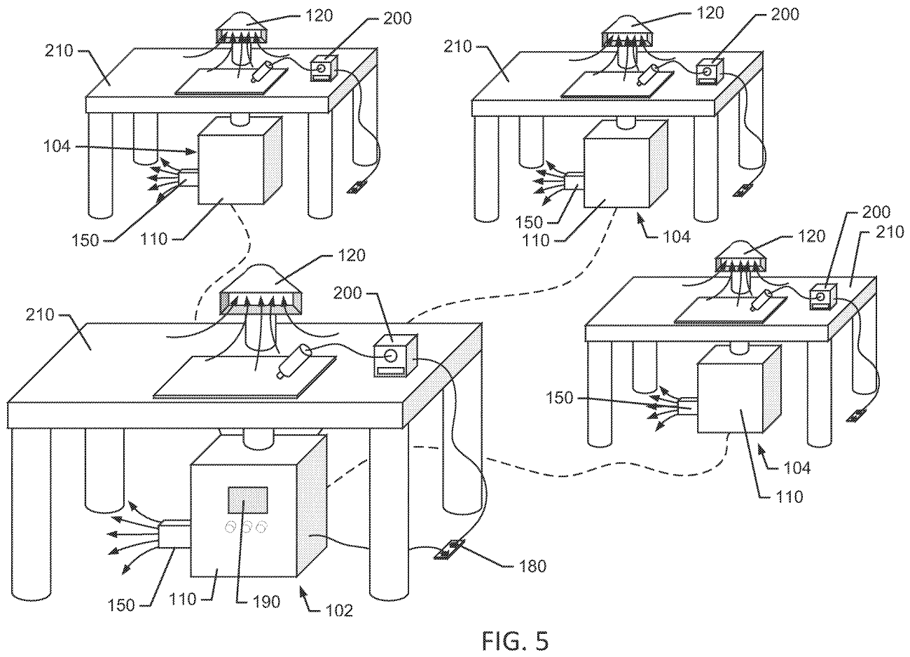

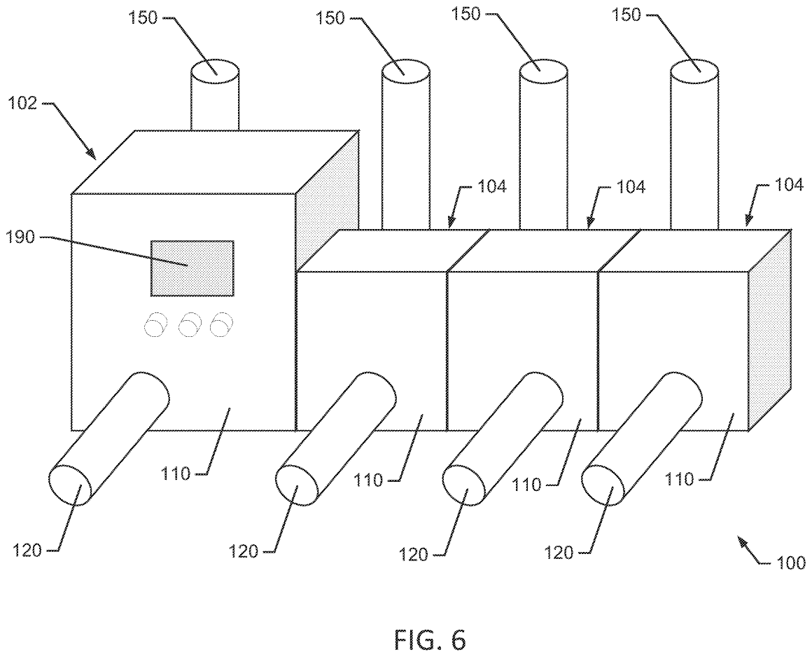

FIG. 1 illustrates a block diagram of the air filtration system 100 according to an example embodiment. FIG. 2 illustrates a block diagram of a main assembly of the air filtration system 100 according to an example embodiment. FIG. 3 illustrates a block diagram of a subsidiary assembly of the air filtration system 100 according to an example embodiment. FIG. 4 illustrates a perspective view of the main assembly of the air filtration system 100 set up at a workstation 210 in accordance with an example embodiment. FIG. 5 illustrates a perspective view of the air filtration system 100 set up at respective workstations 210 in accordance with an example embodiment. FIG. 6 illustrates a perspective view of the air filtration system 100 set up in accordance with an example embodiment.

FIG. 1 depicts a block diagram of the air filtration system 100 according to an example embodiment. The air filtration system 100 may include a main assembly 102 and a plurality of subsidiary assemblies 104 operably coupled to the main assembly 102, according to an example embodiment. FIGS. 2 and 3 depict a block diagram of the main assembly 102 and the subsidiary assembly 104, respectively, of the air filtration system 100 according to an example embodiment. As shown in FIG. 2, the main assembly 102 may include a housing 110, an intake 120, a filter 130, a motor 140, an exhaust 150 and processing circuitry 160. In some cases, the housing 110 may contain the filter 130, the motor 140 and the processing circuitry 160 within the housing 110. The housing 110 may take on any number of shapes and sizes depending on various design constraints such as the volume of air that the main assembly 102 may need to filter, or in what type of setting the main assembly 102 may be used in. For example, in some cases the air filtration system 100 may include relatively a small main assembly 102 and subsidiary assemblies 104, and thus the housing 110 may be configured to be disposed on a desktop/workbench. In other cases the main assembly 102 may be slightly larger and thus the housing 110 may be configured to be disposed under a desk/workbench. In still another case, the main assembly 102 may be even larger still and configured to be disposed nearby as a standalone assembly. Thus, the housing 110 may take on different shapes and/or sizes depending on the particular needs and configuration of each embodiment dictated by the environment and the particular use case of the main assembly 102.

The housing 110 may also include the intake 120 and the exhaust 150 operably coupled thereto. In this regard, and as shown in FIG. 1, air may enter the main assembly 102 through the intake 120 before proceeding to pass through the filter 130 responsive to the operation of the motor 140 driving a fan or other mechanism to facilitate airflow through the main assembly 102. The air may exit the main assembly 102 through the exhaust 150 where it may then reenter the immediate surrounding environment, or be directed elsewhere, responsive to having any airborne particles filtered out of the air by the filter 130. In some cases, the filter 130 may be a high efficiency particulate air (HEPA) filter. In some other cases, different levels/forms of filtration may be desired which may necessitate different types of filters for larger or smaller airborne particulates, and even some gaseous compounds.

In an example embodiment, the exhaust 150 may include an air quality control sensor which may measure a composition of the air exiting the exhaust 150. In this regard, the air quality control sensor may monitor the composition of the air exiting the air filtration assembly 100 to detect the presence of certain particulates and/or gasses being released from the exhaust 150. In other words, air exiting the air filtration assembly 100 through the exhaust 150 should, in theory, be clean after having been passed through the filter 130. Thus, the presence of airborne particles and pollutants should be kept to a minimum when the air filtration assembly 100 is operating properly. In an example embodiment, the presence of airborne particles and pollutants could be an indication of a lack of proper function of the air filtration assembly 100, which may be caused by filter depletion, mechanical failure, or any number of reasons.

In some cases, the air quality control sensor may be a volatile organic compound (VOC) sensor that may measure a density of VOC's in the air exiting the air filtration assembly 100 through the exhaust 150. During normal and proper operation of the air filtration assembly 100, the density of VOC's in the exiting air should be below a predetermined density threshold. In an example embodiment, the air quality control sensor may communicate the measured density with the processing circuitry 160 which may compare the measurement of the composition of the air to the predetermined density threshold. In some cases, the predetermined density threshold may be defined by a user of the air filtration assembly 100, but in most example embodiments, the predetermined density threshold may be set and programmed by the manufacturer of the air filtration assembly 100.

Both the main assembly 102 and each subsidiary assembly 104 may include the air quality control sensor. The air quality control sensor disposed at each subsidiary assembly 104 may communicate with the processing circuitry 160 disposed at the main assembly 102 accordingly. In some cases, the main and subsidiary assemblies (102, 104) may include an air quality control sensor disposed both upstream and downstream of the filter 130 (i.e. the air quality control sensor may be disposed at the intake 120 or at the exhaust 150, or at both). In this regard, the processing circuitry 160 may use the measurements provided by the set of air quality control sensors to more accurately analyze the performance of the respective assemblies (102, 104). The processing circuitry 160 may adjust the operating speed of the motor 140 based on the density of particles or fumes detected by the air quality control sensor accordingly.

As the air filtration system 100 operates, it may generate noise from a plurality of sources. In some cases, the intake 120 may generate noise due to the air entering the respective assemblies (102, 104) at the intake 120. In other cases, the exhaust 150 may generate noise due to the air exiting the respective assemblies (102, 104) at the exhaust 150. In an example embodiment, the housing 110 may also generate noise. The housing 110 may generate noise from the operation of any of the various components of the air filtration system 100 contained within the housing 110 or from the housing 110 itself, perhaps through vibration of the housing 110. In any case, the noise generated by the air filtration system 100 may be nontrivial, and in some cases, substantial. The noise may be made worse by the fact that the air filtration system 100 may be operated indoors in a room that may contain many air filtration assemblies (102, 104). Thus, noise control may be a top priority for the user of the air filtration system 100 in order to improve the user experience with the air filtration system 100. In this regard, the air filtration assembly 100 may include an active noise control (ANC) assembly.

The ANC assembly may detect sound waves of the noise generated by the air filtration system 100 and may convert the sound waves into an electronic signal corresponding to the sound wave. The signal may thus be the electronic representation of the physical sound wave and may therefore correspond to the natural frequency of the noise. A sensor may communicate the signal to the processing circuitry 160, which may include an algorithm in the memory 164 that may analyze the signal from the sensor and shift a phase of the signal by 180°. The processing circuitry 160 may then communicate the phase-shifted signal to a speaker to be emitted out into the environment. The phase-shifted signal emitted by the speaker may interfere with the noise generated by the air filtration system 100 in a destructive manner, effectively reducing the noise to minimal volume levels. In some cases, the processing circuitry 160 may adjust the operating speed of the motor 140 and/or adjust the operation of the ANC assembly based on the measured noise levels.

In an example embodiment, each assembly (102, 104) of the air filtration system 100 may include an identification member. The identification member may be used for various purposes and may perform various functions with respect to the air filtration system 100. In this regard, in some cases, each assembly (102, 104) may not operate until the processing circuitry 160 has first detected the presence of the identification member. The identification member may also be linked to the filter 130 of each assembly (102, 104). Accordingly, the filter 130 may be unique, as indicated by its corresponding identification member. In this regard, the main assembly 102 may detect the identification member to verify the validity of the filter 130 prior to beginning to operate each assembly (102, 104). In other words, the identification member may prevent the use of a counterfeit filter 130 in any of the assemblies (102, 104). Thus, the operation of the air filtration system 100 may not be compromised by the use of an inappropriate filter 130.

In some cases, the identification member may be a near field communication (NFC) card. Thus, in some cases, the main assembly 102 and each subsidiary assembly 104 may include an NFC scanner disposed either at the housing 110 and operably coupled to the processing circuitry 160 or remote from the housing and otherwise operably coupled to the processing circuitry 160. In order to commence operation of each assembly (102, 104), the user may briefly hold the identification member proximate to the NFC scanner in order for the processing circuitry 160 to communicate with the identification member via the NFC scanner and confirm the validity of the filter 130. In an example embodiment, the identification member may communicate other data related to the filter 130 to the processing circuitry 160. In some cases, the identification member may also communicate operating parameters according to which the processing circuitry 160 may control the operation of the air filtration assembly 100. In some cases, the operating parameters may dictate the operating speed of the motor 140 at each assembly (102, 104).

The air filtration system 100 may be powered by a power source 180 which, according to an example embodiment, may be a source of electrical energy such as a battery or a connection to mains power. Operation of the air filtration system 100 may be controlled by the processing circuitry 160 disposed in the main assembly 102, which may be operably coupled to the power source 180 to control the delivery of power to the motor 140 of each respective assembly of the air filtration system 100 accordingly. In this regard, the processing circuitry 160 may also be operably coupled to a user interface 190 that, in some cases, may be disposed at the housing 110 of the main assembly 102. The user interface 190 may be operable by a user to change certain operating parameters of the air filtration system 100, such as powering on/off the main assembly 102 and/or any of the subsidiary assemblies 104 and changing an operating speed of the motor 140 of the main assembly 102 and/or any of the subsidiary assemblies 104, among others. In some cases, the processing circuitry 160 may control the operation of the air filtration system 100 automatically responsive to input from at least one sensor, and without user input from the user interface 190. In another example embodiment, the processing circuitry 160 may operate the various assemblies of the air filtration system 100 at individual set operating speeds for specific time intervals responsive to user input at the user interface 190 selecting such a mode of operation.

The processing circuitry 160 may be configured to provide electronic control inputs to one or more functional units of the main assembly 102 and any of the subsidiary assemblies 104 and to process data received at or generated by the one or more functional units of the air filtration system 100. Thus, the processing circuitry 160 may be configured to perform data processing, control function execution and/or other processing and management services according to an example embodiment. In some embodiments, the processing circuitry 160 may be embodied as a chip or chip set. In other words, the processing circuitry 160 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 160 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 160 may include one or more instances of a processor 162 and memory 164 that may be in communication with or otherwise control other components or modules that interface with the processing circuitry 160. As such, the processing circuitry 160 may be embodied as a circuit chip (e.g., an integrated circuit chip) configured (e.g., with hardware, software or a combination of hardware and software) to perform operations described herein. In some embodiments, the processing circuitry 160 may be embodied as a portion of an onboard computer housed in the housing 110 of the main assembly 102 to control operation of the air filtration system 100.

The memory 164 of the processing circuitry 160 may store information regarding the main assembly 102 and each individual subsidiary assembly 104. For example, the information stored in the memory 164 may include, but not be limited to, the duration of time for which each respective assembly (102, 104) has run, actual and average speeds for the motor 140 at each respective assembly (102, 104), the duration of time that each respective assembly (102, 104) has run since the filter 130 was last changed, an estimate of the remaining life of the filter 130 of each respective assembly (102, 104) based on a total runtime and/or an amount of particles detected in the air, the type of filter 130 installed at each respective assembly (102, 104), the location of each respective assembly (102, 104), a measured pressure in each respective assembly (102, 104) both upstream and downstream of the filter 130, a measured noise of each respective assembly (102, 104), and whether or not the filter 130 has been exposed to certain chemicals (e.g. lead solder) based on user input and/or communication with a sensor or the work tool 200.

In some other cases, the user interface 190 may not be disposed at the housing 110 of the main assembly 102 and may instead be disposed at a personal electronic device of the user. In this regard, the user may be able to configure the operation of the air filtration system 100 wirelessly from a personal electronic device such as a smart phone, a tablet, or a personal computer, any of which may act as the user interface 190 in such embodiments. The user interface 190 may be in communication (i.e. either wirelessly or by wire) with the processing circuitry 160 to receive an indication of a user input at the user interface 190 and/or to provide an audible, visual, tactile or other output to the user. As such, the user interface 190 may include, for example, a display, one or more switches, lights, buttons or keys, speaker, and/or other input/output mechanisms. However, more complex interface mechanisms could be provided in some cases.

The processing circuitry 160 may thus convey information to the user of each subsidiary assembly 104 via the user interface 190 in the form of lights, sounds, and/or messages on a screen. The information conveyed to the user may be regarding the status of the respective assembly (102, 104), the status of the respective filter 130, the filter 130 life and more. In response, the user may input controls at each subsidiary assembly 104 which may allow the user to control each subsidiary assembly 104 without overriding certain parameters set by or at the main assembly 102. In some cases, the processing circuitry 160 may control the operating speed of the motor 140 based on input provided to the user interface 190 of the air filtration system 100. For example, the user may decrease the operating speed of the motor 140 at their respective assembly (102, 104), but perhaps not below a speed determined by the processing circuitry 160 responsive to a density of particles or fumes detected by the air quality control sensor exceeding the predetermined density threshold.

FIGS. 2 and 3 also depict a work tool 200 and a workstation 210, which the air filtration system 100 may be operably coupled to and/or disposed proximate to. In this regard, the workstation 210 may be a table, desk, workbench or any other sort of structure at which a user may perform a work task. In some cases, the workstation 210 may not include a structure at all, and may simply be a general area in which the work tool 200 may be disposed. The work tool 200 may be any number of a variety of tools depending on a task that is desired to be accomplished. For example, the work tool 200 may be a soldering tool, a laser cutting tool, a 3D printer, an injection molding tool, a mill, a lathe, a power saw or many other types of tools commonly used in manufacturing and engineering. For the purposes of illustration and explanation of the components and associated structures of the air filtration system 100, the work tool 200 may be a soldering tool. In an example embodiment, the main assembly 102 may communicate with various workstations 210 and/or various work tools 200 at the workstations 210 and control respective subsidiary assemblies 104 disposed at the workstations 210 based on a status of each individual workstation 210 and/or a status of the various work tools 200 disposed at the workstations 210.

As shown in FIG. 3, each of the plurality of subsidiary assemblies 104 may include all of the components described above in relation to the main assembly 102, except for the processing circuitry 160. In this regard, the operating speed of the motor 140 of each of the subsidiary assemblies 104 may be directly controlled by the processing circuitry 160 based on input into the user interface 190 at the main assembly 102. The absence of processing circuitry 160 in each of the subsidiary assemblies 104 may allow the subsidiary assemblies to be manufactured and sold at a more affordable price than the main assembly 102, or perhaps alternative air filtration products. In some cases, the processing circuitry 160 may communicate with each subsidiary assembly 104 to control the operating speed of the motor 140 wirelessly. In other cases, the processing circuitry 160 may communicate with each subsidiary assembly 104 to control the operating speed of the motor 140 by wire (e.g. Ethernet cable, USB cable, etc.).

FIG. 4 illustrates an air filtration system 100 including only the main assembly 102, according to an example embodiment. FIGS. 5 and 6 each depict the air filtration system 100 including the main assembly 102 and three subsidiary assemblies 104 operably coupled to the main assembly 102, in accordance with an example embodiment. In this regard, the main assembly 102 may be operable on its own as the only assembly in the air filtration system 100. Thus, for example, if a user or team of users only requires the use of a single assembly, the user or team of users may not need to purchase the plurality of subsidiary assemblies 104, and may instead only need the main assembly 102 accordingly, as shown in FIG. 4. If, however, in the future the user or team of users in this example were to require additional air filtration capacity, it may be more cost efficient to purchase the subsidiary assembly 104 to add to their already existing air filtration system 100 including the main assembly 102. In some cases, up to a total of three subsidiary assemblies 104 may be operably coupled to a single main assembly 102 to make up the air filtration system 100. The number of subsidiary assemblies 104 that may be operably coupled to the main assembly 102 in the air filtration system 100 may depend directly on a number of users of the air filtration system 100. Thus, the main assembly 102 and each subsidiary assembly 104 may be disposed at their own respective work tools 200 accordingly. However, in some cases, the practical limit of subsidiary assemblies 104 operably coupled to the main assembly 102 may be three subsidiary assemblies 104. For scenarios requiring further filtration capacity, the user may implement a second air filtration system 100 with another main assembly 102 and respective subsidiary assemblies 104, as desired.

Each subsidiary assembly 104 may be operably coupled to the main assembly 102 independently of each other. In other words, the air filtration system 100 may include the main assembly 102 and an additional one, two or three subsidiary assemblies 104 depending on the requirements of the specific use case for the user or team of users. In some cases, the plurality of subsidiary assemblies 104 may perhaps be disposed at a plurality of workstations 210. Thus, the main assembly 102 and the subsidiary assemblies 104 may each be fully functional assemblies on their own for the respective workstation 210 at which they may be disposed. However, the main assembly 102 may be the only assembly in the air filtration system 100 to include the processing circuitry 160, and as such each of the subsidiary assemblies 104 may be configured to receive control signals from the processing circuitry 160 at the main assembly 102. In this regard, the main assembly 102 and each subsidiary assembly 104 may also operate independently of each other based on signals communicated from the processing circuitry 160. In other words, the operation of a first subsidiary assembly 104 may have no impact on the operation of a second or third subsidiary assemblies 104. If the first subsidiary assembly 104 is operating at a high speed to filter air quickly, the second subsidiary assembly 104 may be operating at an entirely different speed better suited for the particular filtration needs at its respective workstation 210.

As shown in the example embodiment depicted in FIG. 5, each subsidiary assembly 104 may be operably coupled to the main assembly 102 independently of the other subsidiary assemblies 104. The broken lines drawn between the main assembly 102 and each subsidiary assembly 104 may represent the particular operable coupling of those respective assemblies. In other words, the dotted lines may represent a cable or wire physically extending between the main assembly 104 and the respective subsidiary assemblies 104. In other cases, the main assembly 102 and the subsidiary assemblies 104 may be wirelessly operably coupled. In such cases, the broken lines depicted in FIG. 5 may represent the wireless operable coupling of the main and subsidiary assemblies (102, 104). In such cases, the air filtration system 100 may be spread out over various different workstations 210 with each workstation 210 having its own subsidiary assembly 104 disposed proximate to it. Furthermore, in such cases, the subsidiary assemblies 104 may draw power from power sources 180 disposed locally at the respective workstations 210. In some other cases, such as the example embodiment depicted in FIG. 6, the main assembly 102 and the plurality of subsidiary assemblies 104 may be disposed proximate to each other such that the main assembly 102 and the plurality of subsidiary assemblies 104 are physically in contact with at least one subsidiary assembly 104. In such cases, the intake 120 of the main assembly 102 and each subsidiary assembly 104 may include an extended hose that may reach from the air filtration system 100 to a respective workstation 210 to be disposed proximate to the work tool 200 at the respective workstation 210. The main assembly 102 and the subsidiary assemblies 104 may be further operably coupled to one another via contact of electrical terminals disposed at the housing 110 of each of the main assembly 102 and the subsidiary assemblies 104. Thus, the main assembly 102 may control the operation of the subsidiary assemblies 104 via the processing circuitry 160 accordingly.

In some cases, the main assembly 102 may be the only assembly of the air filtration system 100 to be operably coupled to the power source 180. In this regard, the main assembly 102 may provide power to each subsidiary assembly 104. In such cases, the processing circuitry 160 may simply control the operating speed of the motor 140 disposed in each subsidiary assembly 104 by altering the amount of power that is supplied to the motor 140 in each subsidiary assembly 104. In an example embodiment, the processing circuitry 160 may shut down respective subsidiary assemblies 104 by interrupting the power supply to the respective subsidiary assemblies 104.

Some example embodiments may provide for an air filtration system for filtering gas or particles generated responsive to operation of a work tool. The air filtration system may include a main assembly and a plurality of subsidiary assemblies operably coupled to the main assembly. The main assembly and the plurality of subsidiary assemblies may include an intake which may be repositionable relative to the work tool, a housing which may be operably coupled to the intake and may include a filter and a motor, and an exhaust operably coupled to the housing. Air may enter the air filtration assembly at the intake responsive to operation of the motor, before passing through the filter and exiting out the exhaust. The main assembly may further include processing circuitry which may control the operation of both the main assembly and each subsidiary assembly of the plurality of subsidiary assemblies.

In some cases, the air filtration assembly described above may be augmented or modified by altering individual features mentioned above or adding optional features. The augmentations or modifications may be performed in any combination and in any order. For example, in some cases, the main assembly and each subsidiary assembly of the plurality of subsidiary assemblies may operate independently of each other based on signals communicated from the processing circuitry. In an example embodiment, the plurality of subsidiary assemblies may include no more than three subsidiary assemblies operably coupled to the main assembly. In some cases, each subsidiary assembly of the plurality of subsidiary assemblies may be spaced apart from each other and disposed at different workstations. In an example embodiment, each subsidiary assembly of the plurality of subsidiary assemblies may be operably coupled to the main assembly via a cable. In some cases, the main assembly and the plurality of subsidiary assemblies may be disposed proximate to each other such that each of the main assembly and the plurality of subsidiary assemblies may be operably coupled to each other via contact of respective electrical terminals disposed at the main assembly and the plurality of subsidiary assemblies. In an example embodiment, the processing circuitry may control an operating speed of the motor in the main assembly and each subsidiary assembly of the plurality of subsidiary assemblies based on input into a user interface of the main assembly. In some cases, the processing circuitry may communicate with each subsidiary assembly of the plurality of subsidiary assemblies to control the operating speed of the motor wirelessly. In an example embodiment, the processing circuitry may communicate with each subsidiary assembly of the plurality of subsidiary assemblies to control the operating speed of the motor by wire. In some cases, the main assembly may provide power to each subsidiary assembly of the plurality of subsidiary assemblies. In an example embodiment, the processing circuitry may shut down respective subsidiary assemblies by interrupting a power supply to the respective subsidiary assemblies. In some cases, the work tool may be a soldering tool. In an example embodiment, the main assembly and each subsidiary assembly of the plurality of subsidiary assemblies may be disposed at its own respective work tool.

Some example embodiments may provide for a main assembly for an air filtration system for filtering gas or particles generated responsive to operation of a work tool. The main assembly may include an intake which may be repositionable relative to the work tool, a housing which may be operably coupled to the intake and may include a filter and a motor, and an exhaust operably coupled to the housing. Air may enter the main assembly at the intake responsive to operation of the motor, before passing through the filter and exiting out the exhaust. The main assembly may further include processing circuitry configured to control the operation the main assembly and a plurality of subsidiary assemblies that lack local processing circuitry and may be operably coupled to the main assembly.

In some cases, the main assembly described above may be augmented or modified by altering individual features mentioned above or adding optional features. The augmentations or modifications may be performed in any combination and in any order. For example, in some cases, the plurality of subsidiary assemblies may each include an intake which may be repositionable relative to the work tool, a housing operably coupled to the intake, the housing may include a filter and a motor, and an exhaust operably coupled to the housing. In an example embodiment, air may enter each subsidiary assembly of the plurality of subsidiary assemblies at the intake responsive to operation of the motor, before passing through the filter and exiting out the exhaust. In some cases, the processing circuitry may be configured to control the operation of each subsidiary assembly of the plurality of subsidiary assemblies. In an example embodiment, the main assembly and each subsidiary assembly of the plurality of subsidiary assemblies may operate independently of each other based on signals communicated from the processing circuitry.

Some example embodiments may provide for a subsidiary assembly for an air filtration system for filtering gas or particles generated responsive to operation of a work tool. The subsidiary assembly may include an intake which may be repositionable relative to the work tool, a housing which may be operably coupled to the intake and may include a filter and a motor, and an exhaust operably coupled to the housing. Air may enter the subsidiary assembly at the intake responsive to operation of the motor, before passing through the filter and exiting out the exhaust. The subsidiary assembly may be operably coupled to a main assembly that may include processing circuitry configured to control the operation the main assembly and of the subsidiary assembly, which may lack local processing circuitry.

In some cases, the subsidiary assembly described above may be augmented or modified by altering individual features mentioned above or adding optional features. The augmentations or modifications may be performed in any combination and in any order. For example, in some cases, the main assembly and the subsidiary assembly may operate independently of each other based on signals communicated from the processing circuitry. In an example embodiment, the subsidiary assembly may be spaced apart from the main assembly and may be disposed at a different workstation from the main assembly.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An air filtration system for filtering gas or particles generated responsive to operation of a work tool, the air filtration system comprising:
a main assembly; and
a plurality of subsidiary assemblies operably coupled to the main assembly,
wherein the main assembly and the plurality of subsidiary assemblies each comprise:
an intake repositionable relative to the work tool;
a housing operably coupled to the intake, the housing comprising a filter and a motor; and
an exhaust operably coupled to the housing,
wherein air enters the main assembly and each subsidiary assembly of the plurality of subsidiary assemblies at the intake responsive to operation of the motor, before passing through the filter and exiting out the exhaust, and
wherein the main assembly further comprises processing circuitry configured to control the operation of both the main assembly and each subsidiary assembly of the plurality of subsidiary assemblies.

2. The air filtration system of claim 1, wherein the main assembly and each subsidiary assembly of the plurality of subsidiary assemblies operate independently of each other based on signals communicated from the processing circuitry.

3. The air filtration system of claim 1, wherein the plurality of subsidiary assemblies comprises no more than three subsidiary assemblies operably coupled to the main assembly.

4. The air filtration system of claim 3, wherein each subsidiary assembly of the plurality of subsidiary assemblies is spaced apart from each other and disposed at different workstations.

5. The air filtration system of claim 4, wherein each subsidiary assembly of the plurality of subsidiary assemblies is operably coupled to the main assembly via a cable.

6. The air filtration system of claim 3, wherein the main assembly and the plurality of subsidiary assemblies are disposed proximate to each other such that each of the main assembly and the plurality of subsidiary assemblies are operably coupled to each other via contact of respective electrical terminals disposed at the main assembly and the plurality of subsidiary assemblies.

7. The air filtration system of claim 1, wherein the processing circuitry controls an operating speed of the motor in the main assembly and each subsidiary assembly of the plurality of subsidiary assemblies based on input into a user interface of the main assembly.

8. The air filtration system of claim 1, wherein the main assembly and each subsidiary assembly of the plurality of subsidiary assemblies further comprises an air quality control sensor disposed downstream of the filter and configured to measure a density of particles or fumes in the air, and
wherein the processing circuitry controls an operating speed of the motor in the main assembly and each subsidiary assembly based on the density of particles or fumes detected by the air quality control sensor.

9. The air filtration system of claim 1, wherein the main assembly and each subsidiary assembly of the plurality of subsidiary assemblies further comprises an air quality control sensor disposed upstream of the filter and configured to measure a density of particles or fumes in the air, and
wherein the processing circuitry controls an operating speed of the motor in the main assembly and each subsidiary assembly based on the density of particles or fumes detected by the air quality control sensor.

10. The air filtration system of claim 1, wherein the main assembly provides power to each subsidiary assembly of the plurality of subsidiary assemblies.

11. The air filtration system of claim 10, wherein the processing circuitry shuts down respective subsidiary assemblies by interrupting a power supply to the respective subsidiary assemblies.

12. The air filtration system of claim 1, wherein the work tool is a soldering tool.

13. The air filtration system of claim 1, wherein the main assembly and each subsidiary assembly of the plurality of subsidiary assemblies is disposed at its own respective work tool.

14. The air filtration system of claim 1, wherein the main assembly and each subsidiary assembly of the plurality of subsidiary assemblies further comprises an active noise control (ANC) assembly disposed at the intake that detects sound waves of noise generated by the air filtration system and converts the sound waves into an electronic signal corresponding to the sound waves, and
wherein the processing circuitry controls the operating speed of the motor in the main assembly and each subsidiary assembly based on the detected sound waves.

15. The air filtration system of claim 1, wherein the processing circuitry comprises a memory configured to store information about each of the main assembly and each subsidiary assembly of the plurality of subsidiary assemblies, and
wherein the information comprises a duration of time for which the main assembly and each subsidiary assembly of the plurality of subsidiary assemblies has run, actual and average operating speeds for the motor at the main assembly and each subsidiary assembly of the plurality of subsidiary assemblies, the duration of time that the main assembly and each subsidiary assembly of the plurality of subsidiary assemblies has run since the filter was last changed, and an estimate of the remaining life of the filter of the main assembly and each subsidiary assembly of the plurality of subsidiary assemblies.

16. The air filtration system of claim 1, wherein the processing circuitry conveys information to a user of each subsidiary assembly of the plurality of subsidiary assemblies via a user interface in the form of lights, sounds, and/or messages on a screen, and
wherein the information conveyed to the user is a status of the main assembly and each subsidiary assembly of the plurality of subsidiary assemblies, a status of the filter in the main assembly and each subsidiary assembly, and a filter life.

17. The air filtration system of claim 1, wherein a user inputs controls at the main assembly and each subsidiary assembly of the plurality of subsidiary assemblies to control each subsidiary assembly of the plurality of subsidiary assemblies without overriding certain parameters set by or at the main assembly.

18. A main assembly for an air filtration system for filtering gas or particles generated responsive to operation of a work tool, the main assembly comprising:
an intake repositionable relative to the work tool;
a housing operably coupled to the intake, the housing comprising a filter and a motor; and
an exhaust operably coupled to the housing,
wherein air enters the main assembly at the intake responsive to operation of the motor, before passing through the filter and exiting out the exhaust,
wherein the main assembly further comprises processing circuitry configured to control the operation the main assembly and a plurality of subsidiary assemblies that lack local processing circuitry and are operably coupled to the main assembly.

19. The main assembly of claim 18, wherein the plurality of subsidiary assemblies each comprise:
an intake repositionable relative to the work tool;
a housing operably coupled to the intake, the housing comprising a filter and a motor; and
an exhaust operably coupled to the housing,
wherein air enters each subsidiary assembly of the plurality of subsidiary assemblies at the intake responsive to operation of the motor, before passing through the filter and exiting out the exhaust.

20. The main assembly of claim 19, wherein the processing circuitry is configured to control the operation of each subsidiary assembly of the plurality of subsidiary assemblies.

21. The main assembly of claim 18, wherein the main assembly and each subsidiary assembly of the plurality of subsidiary assemblies operate independently of each other based on signals communicated from the processing circuitry.

22. A subsidiary assembly for an air filtration system for filtering gas or particles generated responsive to operation of a work tool, the subsidiary assembly comprising:
an intake repositionable relative to the work tool;
a housing operably coupled to the intake, the housing comprising a filter and a motor; and
an exhaust operably coupled to the housing,
wherein air enters the subsidiary assembly at the intake responsive to operation of the motor, before passing through the filter and exiting out the exhaust
wherein the subsidiary assembly is operably coupled to a main assembly that comprises processing circuitry configured to control the operation the main assembly and of the subsidiary assembly, which lacks local processing circuitry.

23. The subsidiary assembly of claim 22, wherein the main assembly and the subsidiary assembly operate independently of each other based on signals communicated from the processing circuitry.

24. The subsidiary assembly of claim 22, wherein the subsidiary assembly is spaced apart from the main assembly and is disposed at a different workstation from the main assembly.
